(19) United States
(12) Patent Application Publication
(10) Pub. No.: US 2024/0173922 A1
(43) Pub. Date: May 30, 2024

(54) 3D PATHING WITH COMPENSATION FOR NOZZLE MOVEMENT

(71) Applicant: Markforged, Inc., Waltham, MA (US)

(72) Inventors: Corey Hazeltine Walsh, Belmont, MA (US); Suhas Nawada, Concord, MA (US); Benjamin Gallup, Acton, MA (US)

(21) Appl. No.: 18/519,354

(22) Filed: Nov. 27, 2023

Related U.S. Application Data
(60) Provisional application No. 63/428,415, filed on Nov. 28, 2022.

(51) Int. Cl. B29C 64/386; B22F 10/85; B22F 12/90; B29C 64/118; B29C 64/393; B33Y 50/00; B33Y 50/02

(52) U.S. Cl. CPC B29C 64/386; B22F 10/85; B22F 12/90; B29C 64/118; B29C 64/393; B33Y 50/00; B33Y 50/02

(57) ABSTRACT

A 3D printing apparatus and method that compensates for offset in the deposition of print material as a result of nozzle movement. The compensation may include discretizing a path of travel of a 3D print nozzle into segments, compensating each path segment based on an expected offset of print material deposition, and generating a compensated path of travel. The compensation may apply an inversion of a system model that is based on an expected offset of print material deposition relative to the nozzle path of travel.

This application claims the benefit under 35 U.S.C. § 119(e) of U.S. Provisional Patent Application No. 63/428,415, filed Nov. 28, 2022, and titled “3D PATHING WITH COMPENSATION FOR NOZZLE MOVEMENT,” the entirety of which is incorporated herein by reference.

### FIELD OF THE INVENTION

The invention relates to an apparatus and method for 3D printing that compensates for offset in the deposition of print material as a result of nozzle movement.

### BACKGROUND OF THE INVENTION

In Fused Filament Fabrication, toolpaths generated follow patterns, contours, or transitions between offsets and printed areas. Continuous fiber extrusion paths may be generated or traced and/or followed by a 3D printer nozzle. Fiber may further be accordingly deposited in bonded ranks and/or composite swaths. A reinforced fiber path that is to be deposited may be a cloned toolpath, identically formed into an adjacent layer, or reproduced with changes that avoid stacking seams or stress concentrations. Alternatively, reinforced fiber path may further be different toolpaths having different directions of reinforcement may be used in different layers.

### SUMMARY OF THE INVENTION

One aspect of the present invention relates to an apparatus comprising at least one processor; and at least one memory, wherein the at least one memory stores computer-readable instructions which, when executed by the at least one processor, cause the processor to: receive design data corresponding to an object; determine, based on the design data, a path of travel of a nozzle for printing at least a portion of the object; discretize the path of travel into path segments; for each path segment, compensate the path segment to generate a compensated path segment; and generate a compensated path of travel based on the compensated path segments.

Another aspect of the present invention relates to a method comprising receiving design data corresponding to an object; determining, based on the design data, a path of travel of a nozzle for printing at least a portion of the object; discretizing the path of travel into path segments; for each path segment, compensating the path segment to generate a compensated path segment; and generating a compensated path of travel based on the compensated path segments.

Yet another aspect of the present invention relates to a non-transitory computer-readable medium storing a computer program which, when executed by at least one processor, causes the processor to receive design data corresponding to an object; determine, based on the design data, a path of travel of a nozzle for printing at least a portion of the object; discretize the path of travel into path segments; for each path segment, compensate the path segment to generate a compensated path segment; and generate a compensated path of travel based on the compensated path segments.

These and other aspects of the invention will become apparent from the following disclosure.

### BRIEF DESCRIPTION OF THE DRAWINGS

FIGS. 1A and 1B illustrate an apparatus, in accordance with one embodiment.

FIG. 2 is a block diagram illustrating a fiber nozzle, in accordance with one embodiment.

FIG. 3 illustrates an example of a path printed with no compensation, in accordance with one embodiment.

FIGS. 4A-4B illustrate a close-up of the example path printed with no compensation, where FIG. 4A illustrates a close-up of right-angle sections and FIG. 4B illustrates a close-up of circles, in accordance with one embodiment.

FIG. 5 illustrates an example of a first order model in an initial state, in accordance with one embodiment.

FIG. 6 illustrates the example of the first order model in a second state, in accordance with one embodiment.

FIGS. 7A-7D illustrate an example of a simulation algorithm proceeding through coarse steps, in accordance with one embodiment, where FIG. 7A illustrates the example simulation algorithm proceeding through a first portion of the coarse steps, in accordance with one embodiment, FIG. 7B illustrates the example simulation algorithm proceeding through a second portion of the coarse steps, in accordance with one embodiment, FIG. 7C illustrates the example simulation algorithm proceeding through a third portion of the coarse steps, in accordance with one embodiment, and FIG. 7D illustrates the example simulation algorithm proceeding through a fourth portion of the coarse steps, in accordance with one embodiment.

FIG. 8 illustrates an example of a simulation algorithm proceeding through the steps with a finer step size, in accordance with one embodiment.

FIG. 9 illustrates an example of a simulation algorithm proceeding according to the toolpath show in FIG. 3, in accordance with one embodiment.

FIG. 10 illustrates an example of a simulation algorithm proceeding according to the toolpath show in FIG. 3 and a printed fiber print, the simulation and print superimposed for comparison, in accordance with one embodiment.

FIG. 11 illustrates an example of an inverted first order model, in accordance with one embodiment.

FIGS. 12A-12B illustrate an example of filleting a path, in accordance with one embodiment, where FIG. 12A shows the example of the original path, in accordance with one embodiment and FIG. 12B shows the example of the filleted path, in accordance with one embodiment.

FIG. 13 illustrates an example of an ellipse used for a numerical solution, in accordance with one embodiment.

FIG. 14 illustrates an example of an ellipse used for a mathematical solution, in accordance with one embodiment.

FIGS. 15A-15B illustrate a comparison of accuracy of a numerical and mathematical solution, in accordance with one embodiment, where FIG. 15A illustrates the comparison from a zoomed-out perspective, in accordance with one embodiment, and FIG. 15B illustrates the comparison from a close-up perspective, in accordance with one embodiment.

FIGS. 16A-16B illustrate a comparison of accuracy of an inversion, in accordance with one embodiment, where FIG. 16A illustrates the comparison from a zoomed-out perspective, in accordance with one embodiment and FIG. 16B illustrates the comparison from a close-up perspective, in accordance with one embodiment.

FIGS. 17A-17C illustrate a comparison of accuracy of an inversion showing resultant fiber prints, in accordance with one embodiment, where FIG. 17A illustrates a print with no compensation, in accordance with one embodiment, FIG. 17B illustrates a print with convolutional compensation, in accordance with one embodiment, and FIG. 17C illustrates a print with a first order compensation, in accordance with one embodiment.

### DETAILED DESCRIPTION OF THE PREFERRED EMBODIMENTS

In some embodiments, the present invention includes an apparatus and method for a toolpath including inversion function. An inversion function as disclosed inverts a model, such as a first order model, as provided herein to provide a function to compensate between pathing and placement. Modeling of a path may be such that simulation of a compensated path may be the same as or equivalent to an actual printed path, that further may be the same as or equivalent to a desired path or an input path.

In some aspects of the present invention, an inverted model provides or generates control trajectories. In some aspects, such trajectories may place fiber where it is actually desired to be placed by the user.

In some aspects, the present invention relates to an apparatus and method for correcting for deviations and/or misalignments in accuracy of fiber placement. The present disclosure also relates to an apparatus and methods for compensating pathing and extruded segments, particularly on non-straight segments.

In some embodiments of the present invention, a model includes a fiber toolpath and deposition system. A toolpath system may simulate or path an expected location of fiber placement. An expected location of fiber placement can be correlated to expected actual fiber placement and actual fiber placement following a print.

### Printing Systems

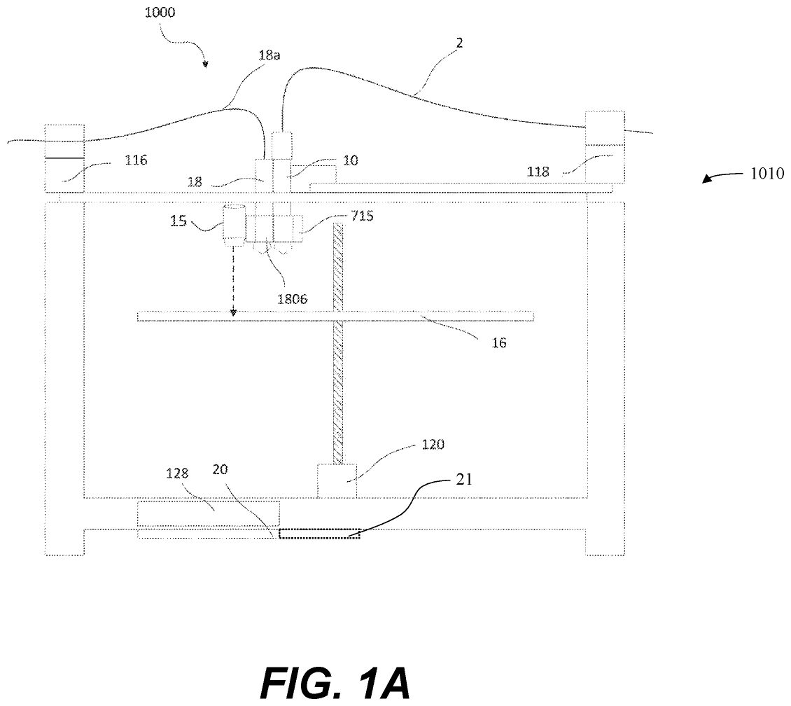

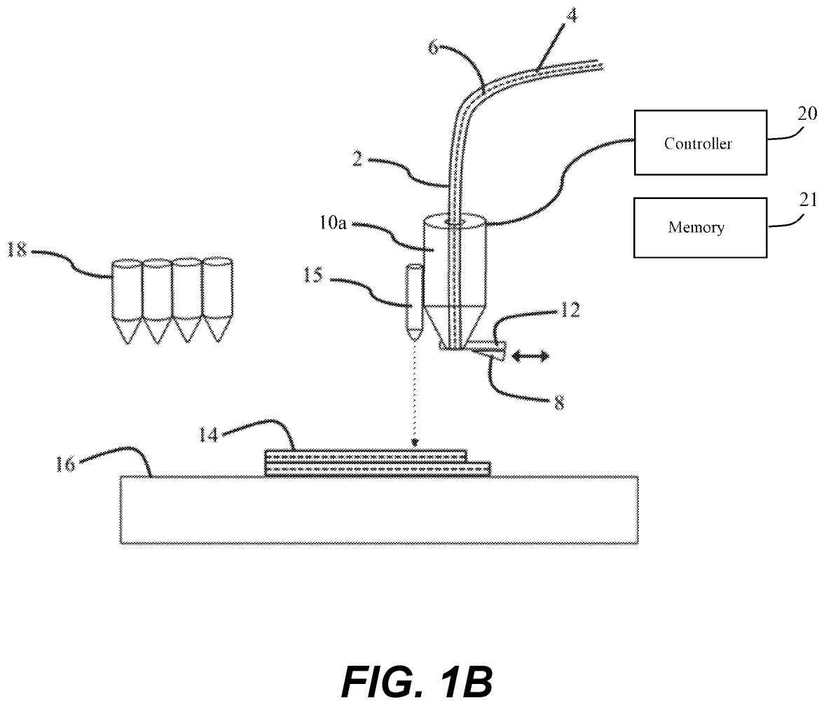

FIG. 1A and FIG. 1B illustrate an apparatus 1000 in accordance with one embodiment of the invention. The apparatus 1000 includes a controller 20, one or more memories 21, and one or more print heads 10, 18. For instance, one head 10 may deposit a metal or fiber reinforced composite filament 2, and another head 18 may apply pure or neat matrix resin 18 a (thermoplastic or curing). In the case of the filament 2 being a fiber reinforced composite filament, such filament (also referred to herein as continuous core reinforced filament) may be substantially void free and include a polymer or resin that coats, permeates or impregnates an internal continuous single core or multistrand core. It should be noted that although the print head 18 is shown as an extrusion print head, “fill material print head” 18 as used herein includes optical or UV curing, heat fusion or sintering, or “polyjet”, liquid, colloid, suspension or powder jetting devices (not shown) for depositing fill material. It will also be appreciated that a material bead formed by the filament 10a may be deposited as extruded thermoplastic or metal, deposited as continuous or semi-continuous fiber, solidified as photo or UV cured resin, or jetted as metal or binders mixed with plastics or metal, or are structural, functional or coatings. The fiber reinforced composite filament 2 (also referred to herein as continuous core reinforced filament) may be a push-pulpreg that is substantially void free and includes a polymer or resin 4 that coats or impregnates an internal continuous single core or multistrand core 6. The apparatus includes heaters 715, 1806 to heat the print heads 10, 18, respectively so as to facilitate deposition of layers of material to form the object 14 to be printed. A cutter 8 controlled by the controller 20 may cut the filament 2 during the deposition process in order to (i) form separate features and components on the structure as well as (ii) control the directionality or anisotropy of the deposited material and/or bonded ranks in multiple sections and layers. As depicted, the cutter 8 is a cutting blade associated with a backing plate 12 located at the nozzle outlet. Other cutters include laser, high-pressure air or fluid, or shears. The apparatus 1000 may also include additional non-printing tool heads, such as for milling, SLS, etc. The apparatus 1000 may also include a touch screen display panel 128 to provide user feedback and accept inputs, commands, and control parameters from the user.

The apparatus 1000 includes a gantry 1010 that supports the print heads 10, 18. The gantry 1010 includes motors 116, 118 to move the print heads 10, 18 along X and Y rails in the X and Y directions, respectively. The apparatus 1000 also includes a build platen 16 (e.g., print bed) on which an object to be printed is formed. The height of the build platen 16 is controlled by a motor 120 for Z direction adjustment. Although the movement of the apparatus has been described based on a Cartesian arrangement for relatively moving the print heads in three orthogonal translation directions, other arrangements are considered within the scope of, and expressly described by, a drive system or drive or motorized drive that may relatively move a print head and a build plate supporting a 3D printed object in at least three degrees of freedom (i.e., in four or more degrees of freedom as well). For example, for three degrees of freedom, a delta, parallel robot structure may use three parallelogram arms connected to universal joints at the base, optionally to maintain an orientation of the print head (e.g., three motorized degrees of freedom among the print head and build plate) or to change the orientation of the print head (e.g., four or higher degrees of freedom among the print head and build plate). As another example, the print head may be mounted on a robotic arm having three, four, five, six, or higher degrees of freedom; and/or the build platform may rotate, translate in three dimensions, or be spun.

FIG. 1B depicts an embodiment of the apparatus 1000 applying the filament 2 to build a structure. In one embodiment, the filament 2 is a metal filament for printing a metal object. In one embodiment, the filament 2 is a fiber reinforced composite filament (also referred to herein as continuous core reinforced filament) may be a push-pulpreg that is substantially void free and includes a polymer or resin 4 that coats or impregnates an internal continuous single core or multistrand core 6.

The filament 2 is fed through a nozzle 10a disposed at the end of the print head 10 and heated to extrude the filament material for printing. In the case that the filament 2 is a fiber reinforced composite filament, the filament 2 is heated to a controlled push-pultrusion temperature selected for the matrix material to maintain a predetermined viscosity, and/or a predetermined amount force of adhesion of bonded ranks, and/or a surface finish. The push-pultrusion may be greater than the melting temperature of the polymer 4, less than a decomposition temperature of the polymer 4 and less than either the melting or decomposition temperature of the core 6.

After being heated in the nozzle 10a, and having its material substantially melted, the filament 2 is applied onto the build platen 16 to build successive layers 14 to form a three-dimensional structure. One or both of (i) the position and orientation of the build platen 16 or (ii) the position and orientation of the nozzle 10 are controlled by a controller 20 to deposit the filament 2 in the desired location and direction. Position and orientation control mechanisms include gantry systems, robotic arms, and/or H frames, any of these equipped with position and/or displacement sensors to the controller 20 to monitor the relative position or velocity of nozzle 10a relative to the build platen 16 and/or the layers 14 of the object being constructed. The controller 20 may use sensed X, Y, and/or Z positions and/or displacement or velocity vectors to control subsequent movements of the nozzle 10a, or platen 16. The apparatus 1000 may include a laser scanner 15 to measure distance to the platen 16 or the layer 14, displacement transducers in any of three translation and/or three rotation axes, distance integrators, and/or accelerometers detecting a position or movement of the nozzle 10a to the build platen 16. The laser scanner 15 may scan the section ahead of the nozzle 10a in order to correct the Z height of the nozzle 10a, or the fill volume required, to match a desired deposition profile. This measurement may also be used to fill in voids detected in the object. The laser scanner 15 may also measure the object after the filament is applied to confirm the depth and position of the deposited bonded ranks. Distance from a lip of the deposition head to the previous layer or build platen, or the height of a bonded rank may be confirmed using an appropriate sensor.

Various 3D-printing aspects of the apparatus 1000 are described in detail in U.S. Patent Application Publication No. 2019/0009472, which is incorporated by reference herein in its entirety.

### Materials

In some embodiments, multiple strands of a polymer or resin and a core including a plurality of reinforcing fibers are co-mingled prior to feeding into a system. The system then heats the materials to a desired viscosity of the polymer resin and applies varying pressures and/or forces in alternating directions to the comingled towpreg to help facilitate fully impregnating the fibers of the towpreg with the polymer or resin. This may be accomplished using a smooth circuitous path including multiple bends through which a green towpreg is passed, or it may correspond to multiple offset rollers that change a direction of the towpreg as it is passed through the system. As the towpreg passes through this circuitous path, the varying forces and pressures help to fully impregnate the polymer into the core and form a substantially void free material. While a co-mingled towpreg including separate strands of reinforcing fibers and polymer resin are described above, embodiments in which a solid core and/or multiple reinforcing fibers are comingled with polymer particles, or dipped into a liquid polymer or resin, and then subjected to the above noted process are also contemplated. In addition to the above, after impregnating the core with the polymer, the substantially void free material may be fed through a shaping nozzle to provide a desired shape. The nozzle may be any appropriate shape including a circle, an oval, a square, or any other desired shape. While a continuous core is noted above, embodiments in which a semi-continuous core is used are also contemplated. Additionally, this formation process may either be performed under ambient conditions, or under a vacuum to further eliminate the presence of voids within the substantially void free material.

In some embodiments, it may be desirable to provide a smooth outer coating on a towpreg corresponding to the substantially void free material noted above. In such an embodiment, a substantially void free material, which is formed as noted above, or in any other appropriate process, is co-extruded with a polymer through an appropriately shaped nozzle. As the substantially void free material and polymer are extruded through the nozzle, the polymer forms a smooth outer coating around the substantially void free material.

The materials used with the currently described three-dimensional printing processes may incorporate any appropriate combination of materials. For example, appropriate resins and polymers include, but are not limited to, acrylonitrile butadiene styrene (ABS), epoxy, vinyl, nylon, polyetherimide (PEI), Polyether ether ketone (PEEK), Polylactic Acid (PLA), Liquid Crystal Polymer, and various other thermoplastics. The core may also be selected to provide any desired property. Appropriate core filaments include those materials which impart a desired property, such as structural, conductive (electrically and/or thermally), insulative (electrically and/or thermally), optical and/or fluidic transport. Such materials include, but are not limited to, carbon fibers, aramid fibers, fiberglass, metals (such as copper, silver, gold, tin, steel), optical fibers, and flexible tubes. It should be understood that the core filaments may be provided in any appropriate size. Further, multiple types of continuous cores may be used in a single continuous core reinforced filament to provide multiple functionalities such as both electrical and optical properties. It should also be understood that a single material may be used to provide multiple properties for the core reinforced filament. For example, a steel core might be used to provide both structural properties as well as electrical conductivity properties.

In some embodiments, in addition to selecting the materials of the core reinforced filament, it is desirable to provide the ability to use core reinforced filaments with different resin to reinforcing core ratios to provide different properties within different sections of the part. For example, a low-resin filler may be used for the internal construction of a part, to maximize the strength-to-weight ratio (20% resin by cross sectional area, for example). However, on the outer cosmetic surface of the part, a higher, 90% resin consumable may be used to prevent the possible print through of an underlying core or individual fiber strand of the core. Additionally, in some embodiments, the consumable material may have zero fiber content, and be exclusively resin. Therefore, it should be understood that any appropriate percentage of resin may be used.

The core reinforced filaments may also be provided in a variety of sizes. For example, a continuous or semi-continuous core reinforced filament may have an outer diameter that is greater than or equal to about 0.001 inches and less than or equal to about 0.4 inches. In one specific embodiment, the filament is greater than or equal to about 0.010 inches and less than or equal to about 0.030 inches. In some embodiments, it is also desirable that the core reinforced filament includes a substantially constant outer diameter along its length. Depending on the particular embodiment, different smoothnesses and tolerances with regards to the core reinforced filament outer diameter may be used. Without wishing to be bound by theory, a constant outer diameter may help to provide constant material flow rate and uniform properties in the final part.

### Printing

In additive manufacturing systems (i.e., 3D printers) involving controlled displacement of system components, the performance of such systems may depend on the accuracy of the controlled displacement. For instance, in the case of a 3D printing system, the accuracy of a 3D-printed part may depend on accurate control of system component displacement along the X, Y, and Z directions. In some aspects, controlled displacement includes movement of mechanical gantry, printhead, and/or print bed components.

The accuracy of a 3D-printed part including depositing continuous fiber may further depend on the accuracy of such controlled displacement. For continuous fiber deposition, accuracy of a controlled displacement process may include three discrete phases of printing, including tacking, ironing, and post-cutting.

Tacking is a process of contacting and adhering a continuous core reinforced filament to a surface. The adherence may be characterized as such that the printhead may move relative to the part, i.e., the printhead may move relative to the point of attachment of the fiber to the surface without lifting the newly deposited material off of the surface.

Prior to a step of tacking may include a step of feeding a continuous core reinforced filament, including a core and a matrix surrounding the core, through a nozzle of the printhead. The nozzle is heated to soften the plastic matrix material.

Specifically, a step of tacking may include contacting a composite continuous fiber to a point on a surface to which the fiber is to be affixed. The composite continuous fiber may be contacted at the point on the surface by the printhead or a heated nozzle of the printhead. The heated nozzle, for example, touches or compresses the continuous fiber against the surface of the substrate opposing the printhead nozzle. The nozzle heat as well as any pressure or time to which the matrix material is exposed causes the matrix material surrounding the core to flow.

Once the printhead and heated nozzle moves away from the location or the point of attachment, then the matrix material begins to cool and solidify in its reflowed shape. The combination of heat, time, pressure that causes the continuous core reinforced filament to stick, tack, and/or adhere to the surface and then solidify on cooling which results in the continuous core reinforced filament being attached to the surface.

The onward drive of the printhead introduces a movement and creates a force that pulls the attached continuous core reinforced filament. The strength of the tack should be greater than the force of the pull of the continuous core reinforced filament so that the filament does not lift off the surface of the substrate.

Ironing, in some embodiments, is a process in which the printhead or nozzle of the printhead is positioned to apply a downward force to the continuous core filament as it is deposited. A downward force may in effect apply a compaction force to the continuous core filament and more specifically the matrix material as it is deposited. The downward force may “iron” the continuous core filament down to the previous layer. As noted, compaction forces applied to the material may offer multiple benefits including increased strength and reduced void space to name a few. This compaction force may be provided by positioning the nozzle at a distance relative to a deposition surface. Compaction relatively may impart on a material a substantial force, an insignificant force, or anything in between.

In some embodiments, it may be desirable to include a cutting mechanism with the three-dimensional printing system. Such a cutting mechanism may be used to provide selective termination in order to deposit a desired length of continuous core filament. Otherwise, the printing process could not be easily terminated due to the deposited material still being connected to the continuous core filament within the nozzle of the printhead. The cutting mechanism may be located at the outlet of the associated printer nozzle or may be located upstream from the outlet. Further, in some embodiments, the cutting mechanism is located between a feeding mechanism for the core material and the outlet of the nozzle. However regardless of the specific configuration and location, the cutting mechanism enables the three-dimensional printing system to quickly and easily deposit a desired length of material in a desired direction at a particular location. In contrast, systems which do not include a cutting mechanism continuously deposit material until the material runs out or it is manually cut. This can limit both the complexity of the parts that can be produced, the speed of the printing process as well as the ability to deposit the material including the continuous core in a particular direction. Depending on the embodiment, the cutting mechanism may also interrupt the printer feed by blocking the nozzle or preventing the feeding mechanism from applying force or pressure to a portion of the material downstream from the cutting mechanism. The fiber tail, post cutting tends to be tough to control. The small section of fiber lacks tension. In some aspects, adjusting a length of post-cut fiber is possible by changing the cut point and allows enhanced control of the tail.

In some embodiments, the substrate that is printed on may be a plastic part material, such a thermoplastic. In some embodiments, the substrate that is printed on may be a plastic part material, such a thermoplastic having chopped carbon fiber. In some embodiments, the substrate that is printed on may be previously deposited fiber material.

Yet another aspect of the present invention relates to an apparatus including one or more processors to execute instructions and memory for storing computer-readable instructions to be executed by the processor and control apparatus, i. e., 3D printer, parameters.

### Existing Modeling

A fiber printing system should be capable of performing the deposition as modeled. Current modeling systems, convolutional compensation models, look to accurately compensate locations where the fiber is intended to be placed.

If a fiber system is physically incapable of printing a fiber path, then the model and inversion will be infeasible. The system may likely still attempt to print the path, but any attempt may inevitably encounter either model or inversion inaccuracy that renders the attempt futile. Fiber path modeling should be feasible for the printing system.

The present disclosure recognizes that when some toolpaths are extruded, the deposited fiber does not lay down exactly where the nozzle travels.

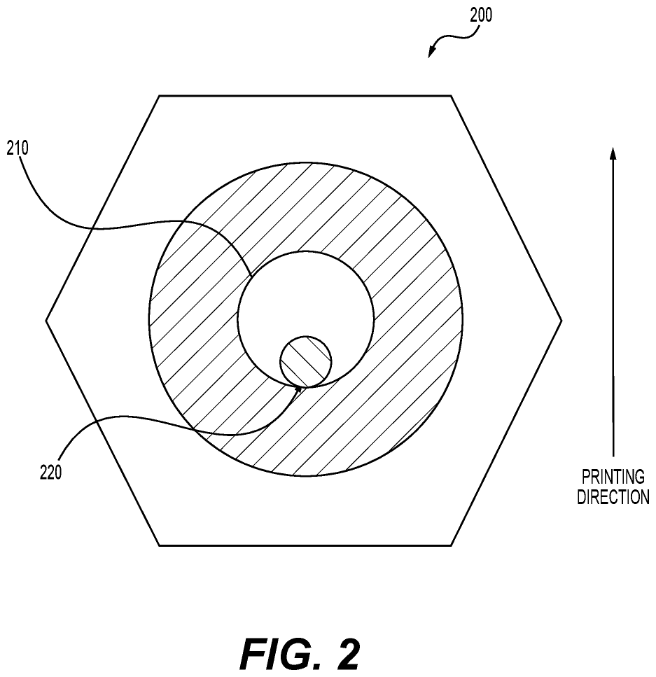

FIG. 2 illustrates a fiber nozzle 200 in accordance with an embodiment. The fiber nozzle 200 includes an opening 210 for depositing material 220. The material 220 may be smaller in diameter than the opening 210. In the example of FIG. 2, the fiber nozzle 200 is depicted has having a circular cross-sectional profile, but it will be appreciated that other profiles may be employed in accordance with the present invention. As the printer prints, the fiber nozzle moves in a printing direction (as shown in FIG. 2). Since the opening 210 is larger in diameter than the diameter of the material 220, during printing, the material (e.g., fiber) may abut an edge of the opening 210 of the fiber nozzle.

In particular, I material may not remain positioned at the center of the fiber nozzle. As a resulIthe material may not be laid down exactly where the nozzle travels. Rather, the material may lag behind the nozzle position or behind the center position of the fiber nozzle. In some embodiments, a toolpath may be manipulated to place fiber where it is desired to go. Specifically, to counteract the lag in material positioning with respect to the fiber nozzle position, the toolpath is adjusted such that the material is placed. The method of counteracting or manipulating fiber toolpath is also referred to herein as compensation or corner compensation.

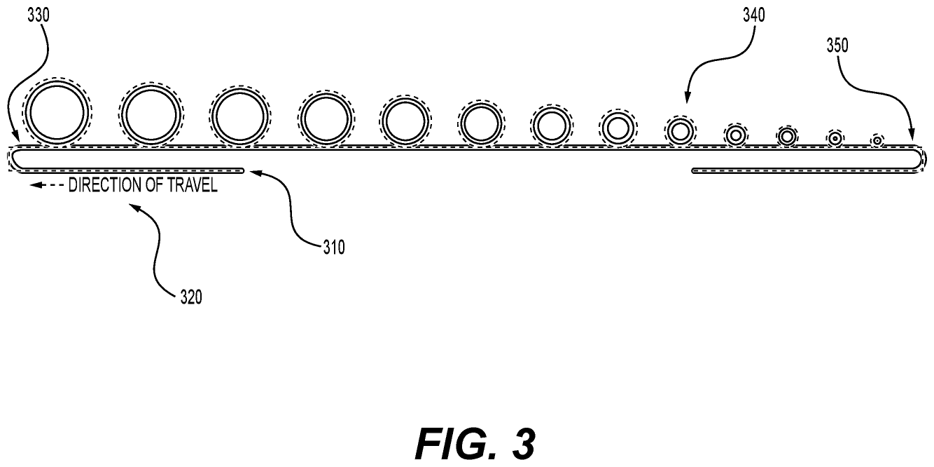

FIG. 3 illustrates an example simple toolpath 310 printed without the compensation of the present invention. IThe toolpath, shown as a hatched line, depicts the nozzle's direction of travel during the print stage. In printing the toIth, the material (e.g., fiber) is deposited according to the toolpath and follows the direction of travel of the nozzle, and is represented by a width 320 of material depicted with solid-line boundaries. The toolpath 310 includes two pairs of right angle turns—a first pair of right angle turns 330 near the beginning of the toolpath 310 and a second pair of right angle turns 350 near the end of the toolpath 310. The toolpath 310 also includes a series of circular shaped loops 340. The particular example of series of circular shaped loops along the path in FIG. 3 is configured with each successive loop having a smaller diameter than the previous loop.

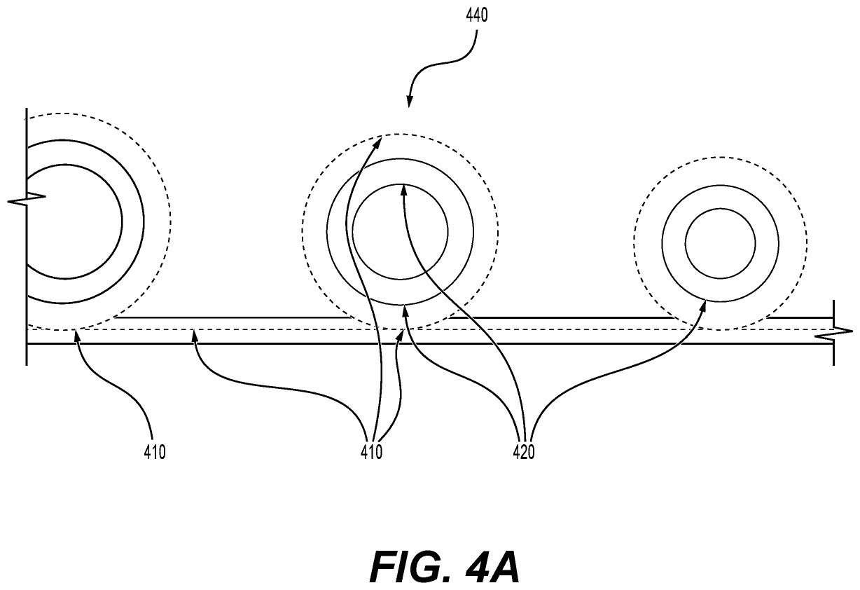

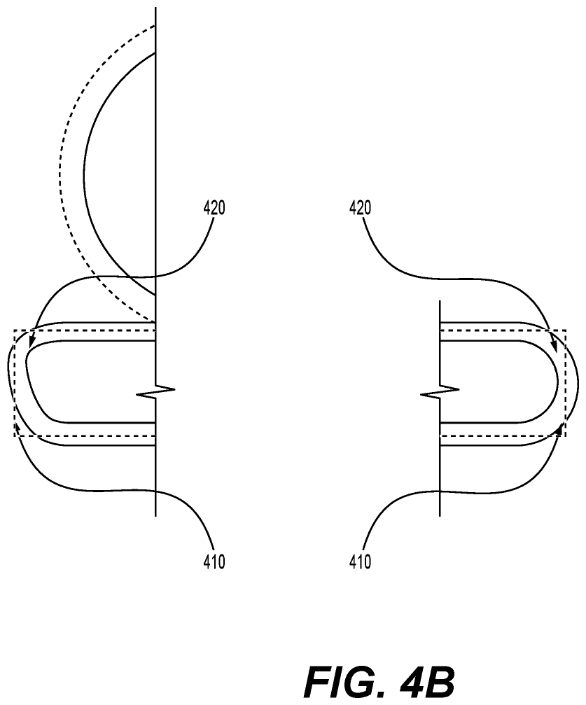

FIG. 4 illustrates enlarged portions of the simple toolpath 310 of FIG. 3, printed with no compensation. FIG. 4A shows toolpath line 410, which depicts the nozzle's direction of travel during the print stage. The material (e.g., fiber) 420 was deposited based on the nozzle exactly following the direction of travel defined by the toolpath 410. As can be seen, the deposited fiber 420 significantly deviated from the nozzle travel/desired path 410 in multiple locations. The deposited fiber circle 420 is significantly smaller in radius than the nozzle travel/desired path 410. According to the nozzle travel/desired path 410, the fiber should be centered on the line, but deposited fiber circle 420 appears quite inset. As shown in FIG. 2, this is especially true for the smaller diameter circles.

FIG. 4B illustrates an enlarged image of the pair of right-angle turns, i.e., corners that were formed at the beginning and end of the toolpath. As shown with the two pair of right-angle turns at the beginning of the toolpath as well as the end of the toolpath, the deposited fiber 420 significantly deviated in multiple locations from the desired path 410, i.e., the path traveled by the nozzle. In contrast to the sharp right angle turns of the nozzle travel/desired path 410, the printed fiber 420 was “smoothed out” and rounded. That is, the printed fiber did not have very high fidelity with the path traveled by the nozzle.

### Modeling

A model inversion should accurately compensate locations where the fiber is intended to be placed. If an inversion for the model is inaccurate, the inversion likely cannot control the system well. That is, for a model simulate (compensate (path)) !=path, if an inversion is inaccurate, then it is irrelevant whether a model is representative of what the user desires, as the print will likely not be accurately formed. An inversion should be accurate for placement of fiber.

In some embodiments, the present disclosure provides an inversion function that inverts the model. In some aspects, a model may further include finding a function to compensate between pathing and placement. Modeling of a path may be such that simulation of a compensated path may be the same as or equivalent to an actual printed path.

In some embodiments, an inverted model provides or generates control trajectories. In some aspects, such trajectories may place fiber where it is actually desired to be placed by the user.

It can often be extremely difficult to invert complex nonlinear system models. Therefore, often when inverting it is beneficial try to strike a balance. For example, a more simplified model may be selected for inversion over a model that might be more accurate but would generally be more difficult to invert.

A model or simulation should represent locations where fiber is intended to be placed. If a simulation is inaccurate compared to the real system, then it may become irrelevant that the fiber is perfectly inverted with the model, since fiber will not placed in the location provided by the model. An inaccurate system model will not be helpful. A successful model should accurately represent the locations where fiber is intended to be placed and when deposited using the model, place fiber where the user desires it to be located.

### First Order System

The present disclosure includes a first order modeling system, such that a simple first order system compensation model may be used herein as a result of observing and attempting to mathematically describe a simplified kinematic model of the nozzle diagram.

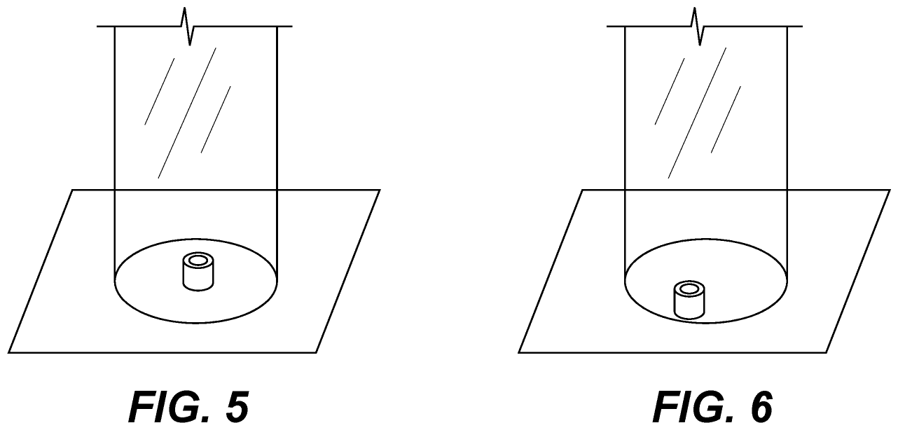

FIG. 5 illustrates an example of an intuitive representation of such a simplified kinetic model. This model is somewhat useful because it is helpful to understand the kinematics of the system and the observed compensation. FIG. 5 may represent a fiber displaced within a nozzle during deposition. FIG. 5 illustrates a flat surface, a large cylinder (e.g., represented by a plastic drinking cup or glass for explanative purposes) that represents the nozzle opening, and a smaller cylindrical (or vaguely cylindrical) item that is smaller than the mouth of the large cylinder and that is placed within the large cylinder. The flat surface may be representative of the print bed. The large cylinder may be representative of the nozzle. The cylindrical item may be representative of the continuous fiber filament disposed of within the nozzle.

FIG. 6 illustrates the example representation of FIG. 5 when the large cylinder is moved (comparable to a nozzle movement). In FIG. 6, the large cylinder has been moved on the flat surface. It is observed that the smaller cylindrical item is dragged or pulled by the trailing edge of the large cylinder 620. In this model, the edge of the large cylinder 620 represents the nozzle. The small cylindrical item that is dragged by the edge of the cup represents the fiber that starts abutting the edge of the fiber nozzle and moving around depending on how the nozzle moves on the surface of the print bed.

### Input

The present disclosure provides a strategy for fiber placement with high fidelity. An input into the system, in its simplest form include a path of the form {x: number, y: number}[ ] which indicates the path which the nozzle moves during its travel and a characteristic radius, R: number, which describes th′ system's behavior. This combination produces code that generates interesting fiber geometry sweeps.

### Simulation Procedure

An exemplary model, a TrailingPoint model, is an exemplary simulation procedure that describes the nozzle, its motion, and material deposition. The TrailingPoint model includes, for example, steps of:
1. Resampling of an input path to some arbitrary fine step size between waypoints;
2. Initializing;
   (a) TrailingPoint=path[0], the first position on the input path
   (b) simulatedFiberPath=[trailingPoint]
3. Stepping a simulated circle with radius R along the resampled path from the Resampling step, step (1) such that at each step, the circle is centered on the next waypoint;
   (a) If TrailingPoint lies inside of the circle, continue
   (b) If TrailingPoint is outside of the circle, update it according to the following steps:
      (i) Drawing a line from the previous TrailingPoint to the new circle center
      (ii) Finding the point along the drawn line which lies on the edge of the simulated circle
4. Adding TrailingPoint into simulatedFiberPath→simulatedFiberPath. push(trailingPoint)

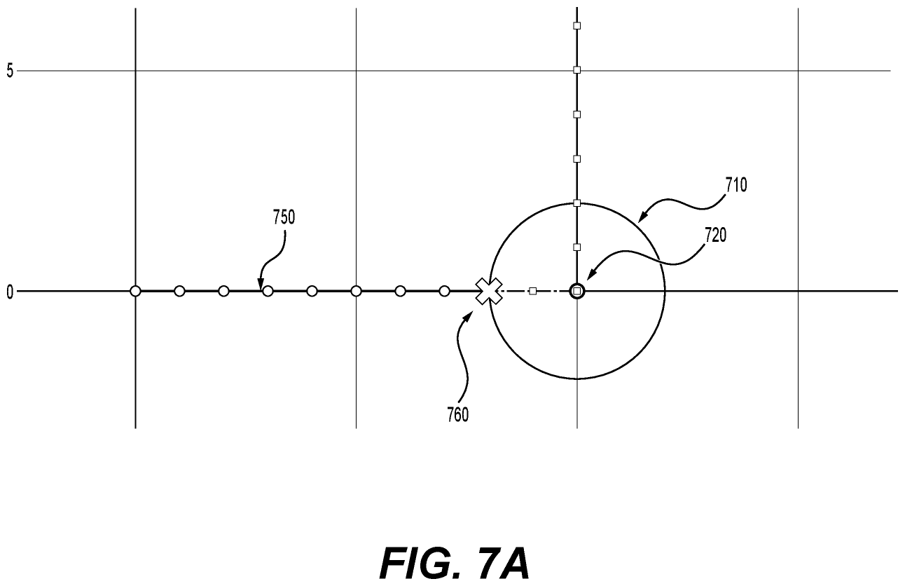

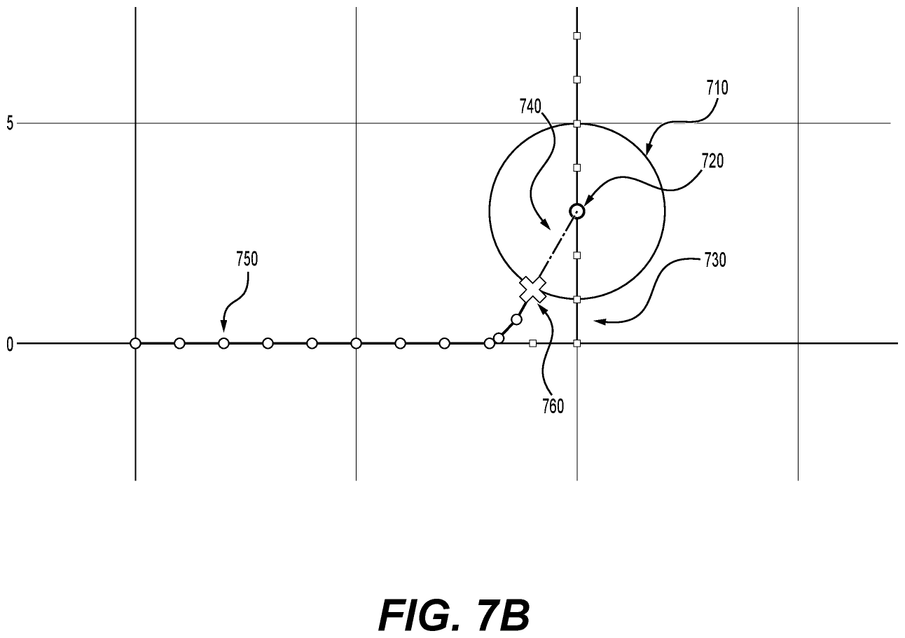

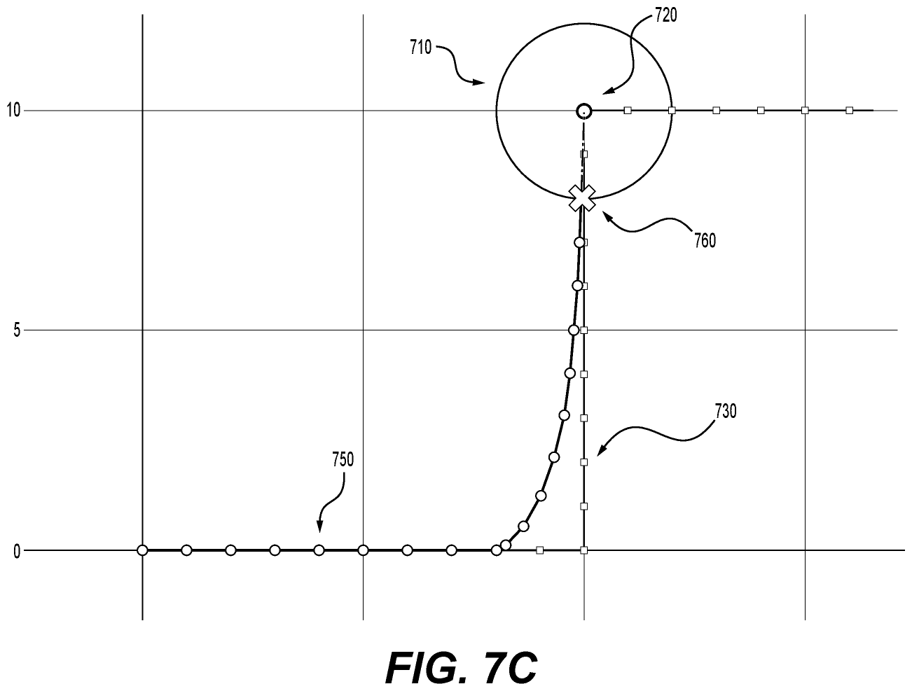

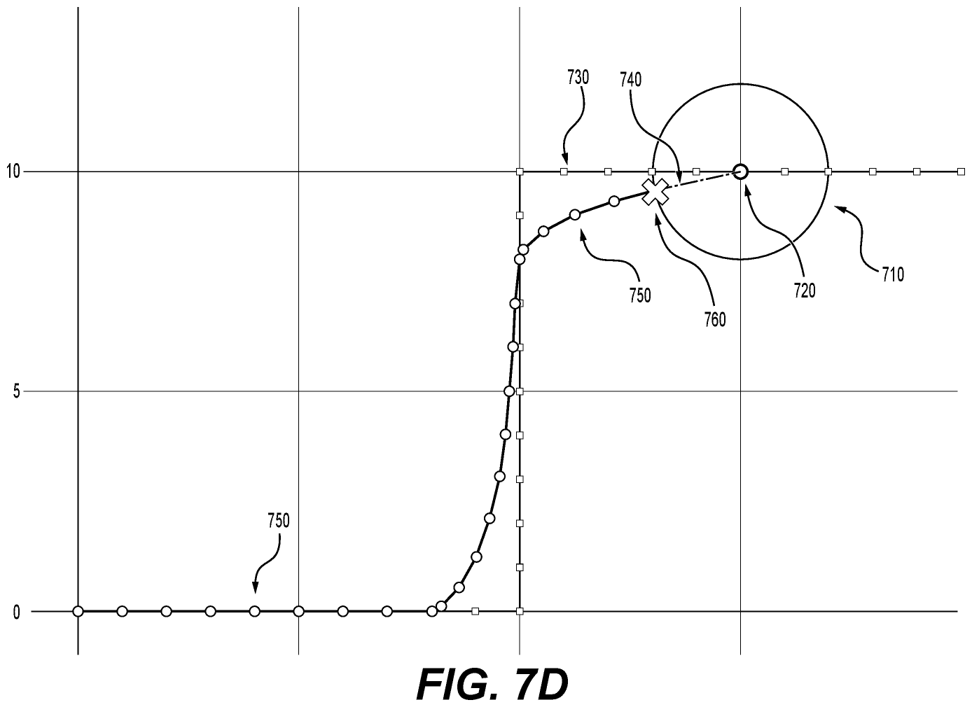

FIGS. 7A-7B illustrate graphs representing how the simulation algorithm proceeds with a relatively coarse step size. FIG. 7A shows a graph representing a nozzle moving along straight path approaching a first curve. Movement of the nozzle is defined by the Nozzle Center Position 720, Nozzle Radius 710, Simulated Fiber Path 750, and the TrailingPoint 760.

FIG. 7B shows a graph representing a nozzle moving along a right-angled path, a travelled path 730. Movement of the nozzle is defined by the Nozzle Center Position 720, Nozzle Radius 710, Travelled Path 730, Simulated Fiber Path 750, the TrailingPoint 760, and the Last TrailingPoint to Nozzle Center. The Simulated Fiber Path 750 does not accurately follow the Travelled Path 730 of the Nozzle.

FIG. 7C shows a graph representing a nozzle moving along what is approaching straight path. Movement of the nozzle is defined by the Nozzle Center Position 720, Nozzle Radius 710, Simulated Fiber Path 750, Travelled Path 730, the TrailingPoint 760. As the path approaches a straight path, the Simulated Fiber Path 750 begins to align and accurately follow the Travelled Path 730 of the Nozzle.

FIG. 7D shows a graph representing a nozzle moving along a right-angled path, a travelled path 730. Movement of the nozzle is defined by the Nozzle Center Position 720, Nozzle Radius 710, Travelled Path 730, Simulated Fiber Path 750, the TrailingPoint 760, and the Last TrailingPoint to Nozzle Center. The Simulated Fiber Path 750 does not accurately follow the Travelled Path 730 of the Nozzle.

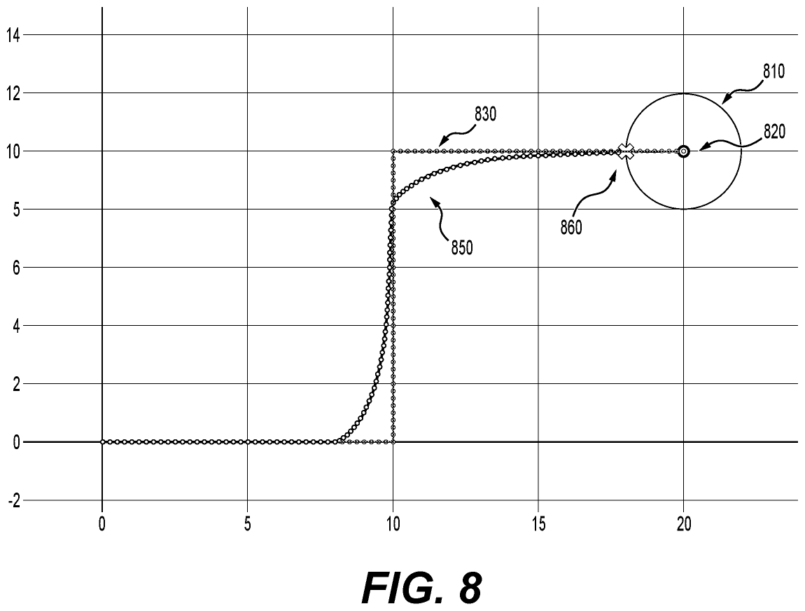

FIG. 8 shows a graph representing a nozzle moving along a pair of right-angled paths as followed in FIG. 7 with the simulation algorithm proceeding with a finer step size. A finer step size produces a similar but more fine result. FIG. 8 shows a graph representing a nozzle moving along a right-angled path, a travelled path 830. Movement of the nozzle is defined by the Nozzle Center Position 820, Nozzle Radius 810, Travelled Path 830, Simulated Fiber Path 850, the TrailingPoint 860, and the Last TrailingPoint to Nozzle Center. The Simulated Fiber Path 850 does not accurately follow the Travelled Path 830 of the Nozzle. Thus, a discretization parameter is not of terrible importance so long as such that the discretization level is sufficiently fine such that it is not misrepresenting (e.g., “jumping over”) important details in the path.

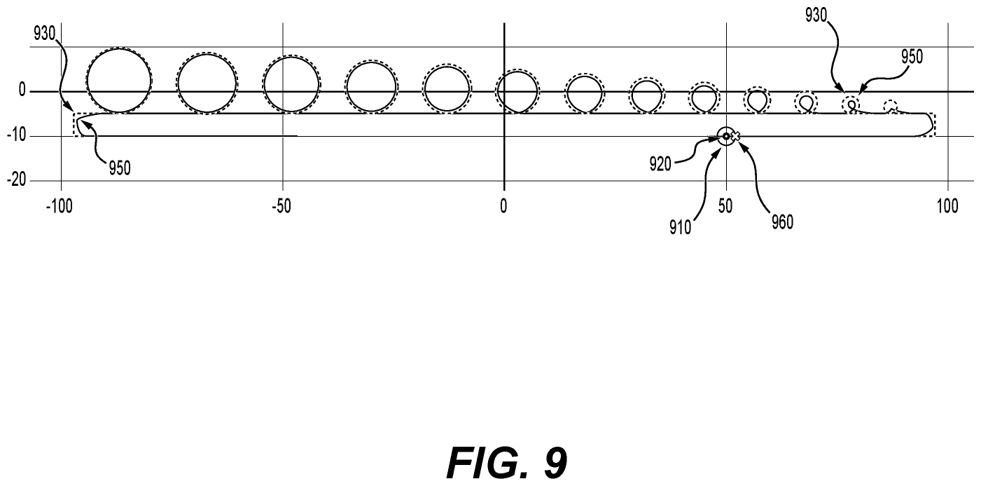

FIG. 9 shows a graph of a simple toolpath modeled according to the TrailingPoint algorithm. The graph represents a nozzle moving along a toolpath that includes two pairs of right angle turns, a first pair of right angle turns near the beginning of the toolpath and a second pair of right angle turns near the end of the toolpath. The toolpath also includes a series of circular shaped loops. The series of circular shaped loops along the path is shown having each successive loop with a smaller diameter. Movement of the nozzle is defined by the Nozzle Center Position 920, Nozzle Radius 910, Travelled Path 930, Simulated Fiber Path 950, and the Last TrailingPoint to Nozzle Center 960. The Simulated Fiber Path 950 does not accurately follow the Travelled Path 930 of the Nozzle, this is particularly true for smaller circles.

High-level dynamics of fiber placement can be captured with reasonable accuracy with a TrailingPoint model, such as disclosed above. TrailingPoint may however not be fully modeling an instance where a fiber pushes up against an orifice of a nozzle.

TrailingPoint may more accurately model a circumstance in which a matrix material, such as a thermoplastic that surrounds the fiber, is heated and placed into a softened state so that when the composite fiber having the softened matrix material is attached to the surface and cools the matrix to solidify and form an attachment at the surface to the point that it takes more force to pull that composite fiber away from the substrate than it does to pull more fiber through the extrusion system.

A process of cooling and attachment, or at least sufficient cooling to resist lifting the fiber from the surface, may occur as the fiber is extruded on the surface, immediately after deposition on the surface, or within a period following deposition. The fiber may be affixed, bonded, adhered onto or down on the surface opposite the extrusion nozzle and trailing a short distance behind the nozzle.

A TrailingPoint model may not capture various complicated viscous effects that can occur in the melt region right below the nozzle. The TrailingPoint model may also not capture complicated effects that may result from the fact that the fiber is really a bundle of smaller fibers, which smush out and can fold over each other. The TrailingPoint model may not capture the fact that the fiber has some finite width.

Without being bound to any theory it is believed that possible model inaccuracy may become more apparent as the system attempts to path extremely tight/convoluted geometry that contains high-frequency information.

Changing control levers impacts the print process in somewhat unexpected ways such as, for example, z-strength, fiber fraying, etc. The TrailingPoint model however may show some surprising stability to control changes, including, for example: changes to print temperature, changes to extrusion rate, changes to print speed, and changes to printhead z-height seem to have little effect on model accuracy. Importantly, where and how fiber attached to a surface of a part, nozzle geometry may be a significant predictor of the best “R” value for any given system.

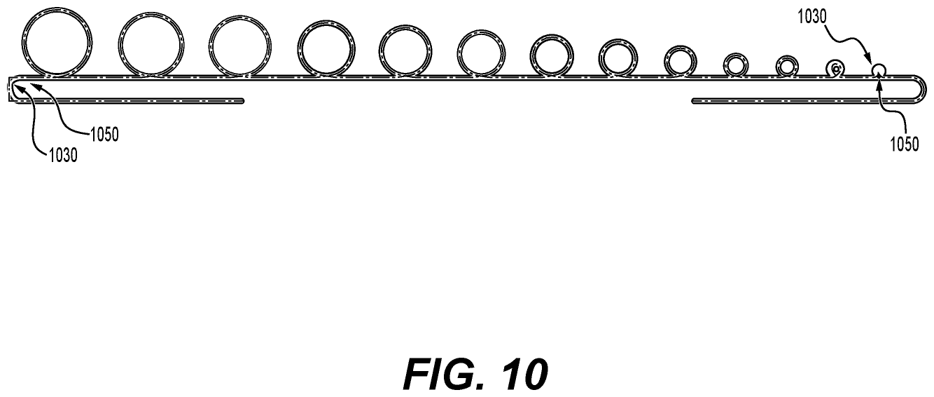

FIG. 10 shows an example of image of a simple toolpath modeled and a printed fiber path according to the TrailingPoint algorithm. The toolpath and nozzle moving along a toolpath includes two pairs of right angle turns, a first pair of right angle turns near the beginning of the toolpath and a second pair of right angle turns near the end of the toolpath. The toolpath also includes a series of circular shaped loops. The series of circular shaped loops along the path is show having each successive loop with a smaller diameter.

A comparison between the model where (R=1.9) and actual fiber placement shows that the correlation between these two is quite accurate. Notably, in this example, the R value is slightly larger than the outer surface area diameter of our nozzle. The larger R value adds some credence to the theory that that the model may be modeling where the matrix of the fiber cools, solidifies and attaches to the surface. Movement of the nozzle is defined by a Travelled Path 1030 and the Simulated Fiber Path 1050. The Simulated Fiber Path may be less accurate for smaller circles.

### Inverting a First Order Model

The present disclosure includes an inversion of a first order model system as provided herein.

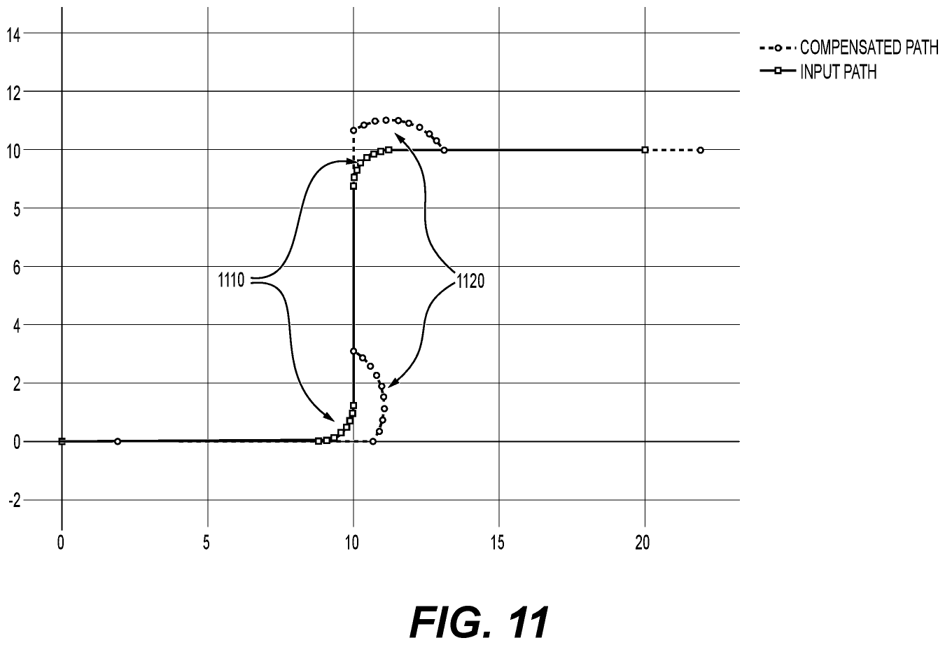

In some embodiments, a kinetic model as disclosed may be inverted. As shown in FIG. 11, a first order system model can be inverted. The kinetic model 1100 includes an input path 1110 and a compensated path 1120.

### Filleting Inputs

In some aspects, such as from a kinetic model as disclosed above, it may be helpful when attempting to invert paths to have a feasible input. Therefore, when working with path compensation, before compensating, the input path should be filleted so that it is C1 continuous. Continuous core filament is generally not designed to instantaneously bend. In practice, continuous core filament will have some corner radius. Filleting inputs reflects these corners. Additionally, fileting tangent continuity implies positional continuity in the compensated paths.

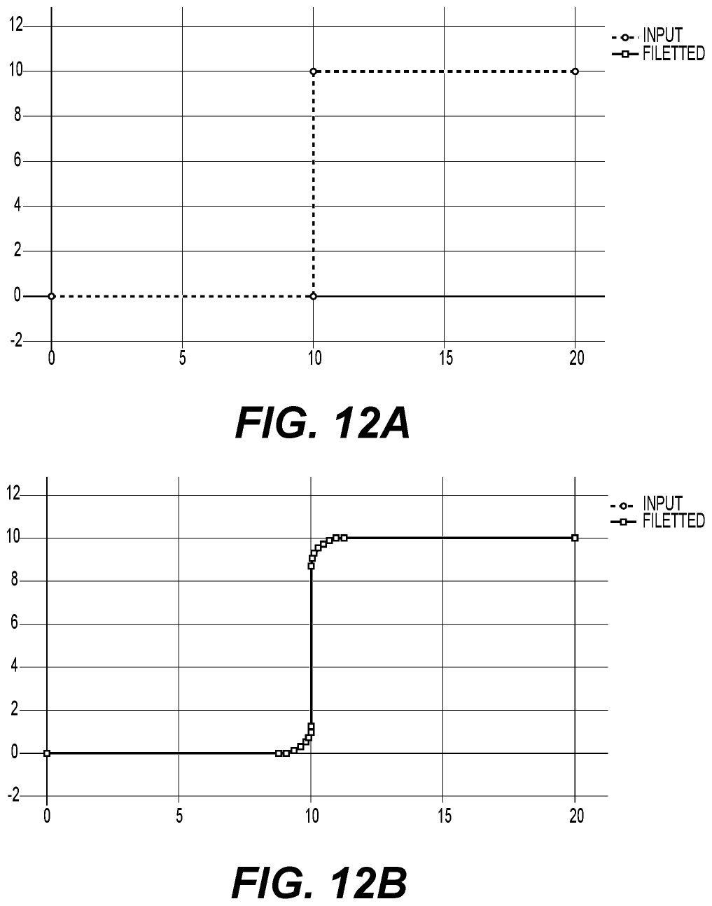

FIGS. 12A-12B illustrate filleting paths, where FIG. 12A shows the original path and FIG. 12B shows the fileted, C1 continuous path.

### Input

In some embodiments, when applying an inversion, there are two inputs, same as in the simulation case.

In an example path, of the form PiecewiseTrajectory, which indicates the path where the fiber is desired to be placed. This path may include line segments and circle-arc segments. The overall input has C1 (tangent) continuity. This path typically can come from adding fillets to some piecewise-linear path of the form {x: number, y: number}[ ].

A characteristic radius R: number describes th′ system's behavior.

### Numerical Solution

A simple numerical inversion exists, based on the process that includes:
1. Discretizing the desired path to a some step size h so that we have a piecewise linear path of the form {x: number, y: number}[ ]
2. Compensating the path
3. Iterating over each path segment, and shifting the end point along the tangent vector by R
4. Accumulating all shifted end points

The above method may be used to provide a numerical solution but shifting the midpoints of each segment may be preferable based on improved discretization error characteristics. Without being bound to a theory, it is believed that shifting the end point tends to overshoot the exact solution, shifting the start point tends to undershoot, whereas the midpoint methodology is similar and, in the limit, where h approaches zero.

### Sampling

The numerical solution above indicates that the solution is to sample the path at some step size h. However, a constant step size, h, is likely not needed. In fact, to bound the error with respect to the exact solution, includes sampling the input path prior to compensation.

Line segments throughout the input should be sampled with two end “caps.” These end caps are short segments at the beginning and end of these line segment.

The compensated path has a bounded error with respect to the exact solution.

Sampling arcs, i.e., the max distance between the true arc and an approximation is some value L.

Approximating a compensated arc, L can be based on a ratio between radii of the input and deformed arc. A value of L should be within positioning tolerance, i.e., a maximum imprecision of the flattened path. L should be e.g., somewhere in the range of 10 um might be appropriate for the system disclosed herein.

A first approximation of an arc may be calculated using a path of straight lines. Sampling and numerically calculating a solution may be faster, less computing, while maintaining comparable accuracy when compared with other solutions, such as those including solving any trigonometric constraints. The method includes steps of calculating straight line segments. The path should be within a specified distance of the arc, circle.

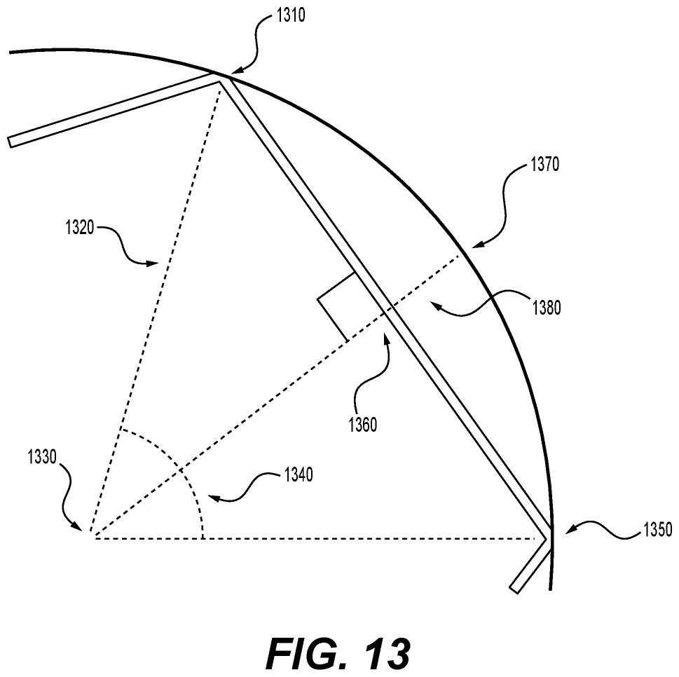

As depicted in FIG. 13, a process of flattening an ellipse 1300 can be approximated by line segments or path segments according to the following.

Number of Segments=π/cos⁻¹(1−1380/1320)

1320=radius of the circle;length(1310·1330)

1380=maximum ‘imprecision’ of the flattened path;length(1360·1370)

1340=360°/Number of Segments=2×π/Number of Segments

length(1330·1360)−=1320−1380

cos(1340/2)=length(1330·1360)/1320

cos(1340/2)=length(1330·1360)/1320

1340=2x−os⁻¹(1−1380/1320)=2xπ/Number of Segments

Number of Segments=π/cos⁻¹(1−1380/1320)

### Mathematical Solution

In some embodiments, before applying a model inversion includes a step of filleting paths. Therefore, input paths are of a form PiecewiseTrajectory which can include line segments and circle-arc segments, and overall input has C1 (tangent) continuity. When considering this input, it is possible to invert the system model.

### Line Segments

Methods of inverting the system model can include individually compensating the constituent individual path line segments. Once we have compensated the segments, we will have a compensated PiecewiseTrajectory, which can later be sampled into a {x: number, y: number}[ ] path for later processing/coding.

A process for compensating line segments can include a step of shifting the whole line segment forwards along a tangent direction of that segment by the radius, R. The fiber path is simulated to trail the nozzle center by the radius, R, shifting the fiber path forward by R therefore should counteracts the trailing effect.

### Arc Segments

Methods of inverting the system model can include individually compensating the constituent individual arc segments, including determining a deformed arc segment that inverts our system model, such that following the deformed arc would result in a simulated fiber path that lies on the input arc.

An input arc, arc, which is of type ArcSegment in a slicer program, which input arc may be defined by the following:
arc.radius: number=the arc's radius
arc.center: {x: number, y: number}=the arc's center . . .
arc.angles: [number, number]=the start and end angles where this arc begins/ends
   The start point of the deformed arc should be the start point of the input arc shifted along the initial tangent angle by R, the radius. The end point of the deformed arc should be the end point of the input arc shifted along the final tangent angle by R, the radius.

Where the start point or the end point of the deformed arc should be the end point of the input arc shifted along the final tangent angle by R, the radius, the compensated path should have C⁰ continuity function so therefore it makes sense it would match the strategy for the line segments on either side of the arc.
The radius of the deformed arc should be as follows: sqrt (arc.radius\hat{ }2+R\hat{ }2).
The arc will have the same magnitude or angula-range-aka arc.an-les[1]−arc.angles[0]=deformedArc.an-les[1]-deformedArc.angles[0].
If the input arc curves along a clockwise direction, then the output arc will also curve along a clockwise direction.

At each point along the arc a right triangle forms with arc.radius at one leg, R, the radius, on the other leg, and therefore the hypotenuse is the radius of the compensated arc.

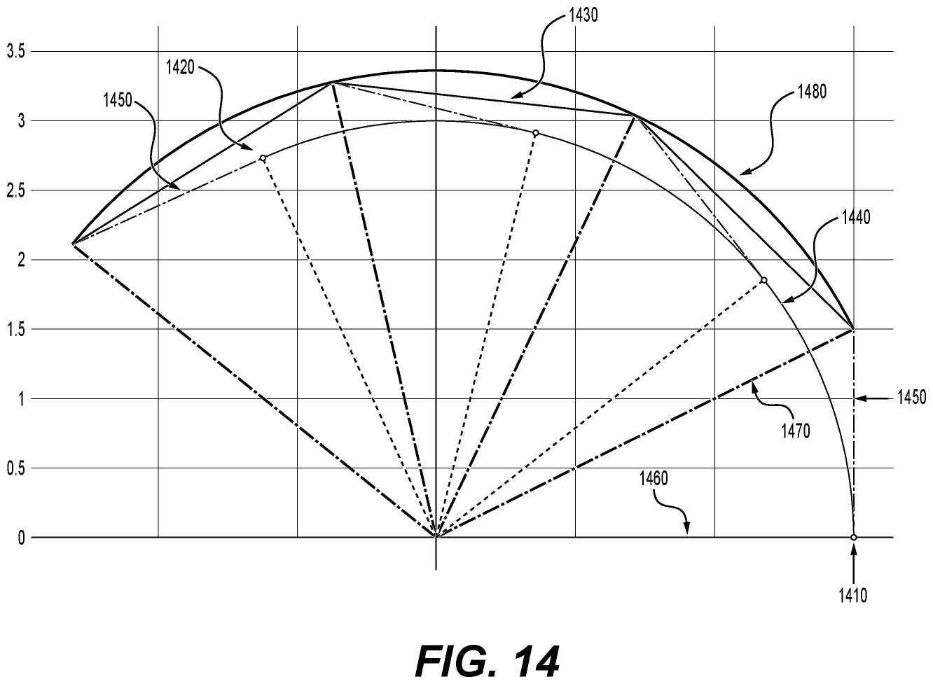

FIG. 14 illustrates compensating a random arc at four points along the arc.

A start point 1410 of a deformed arc 1440 should be the start point of the input arc 1430 shifted along the initial tangent angle by R, the radius 1450.

The end point 1420 of the deformed arc 1440 should be the end point of the input arc 1430 shifted along the initial tangent angle by R, the radius 1450.

As explained, the ratio between radii of the input and deformed arc is known, in particular this ratio is sqrt (arc.radius\hat{ }2+R\hat{ }2), 1470/arc.radius, 1460

A compensated arc 1480 shows a result of compensating every point along the path, approaching an infinitely small step.

### Numerical and Mathematical Solutions Comparison

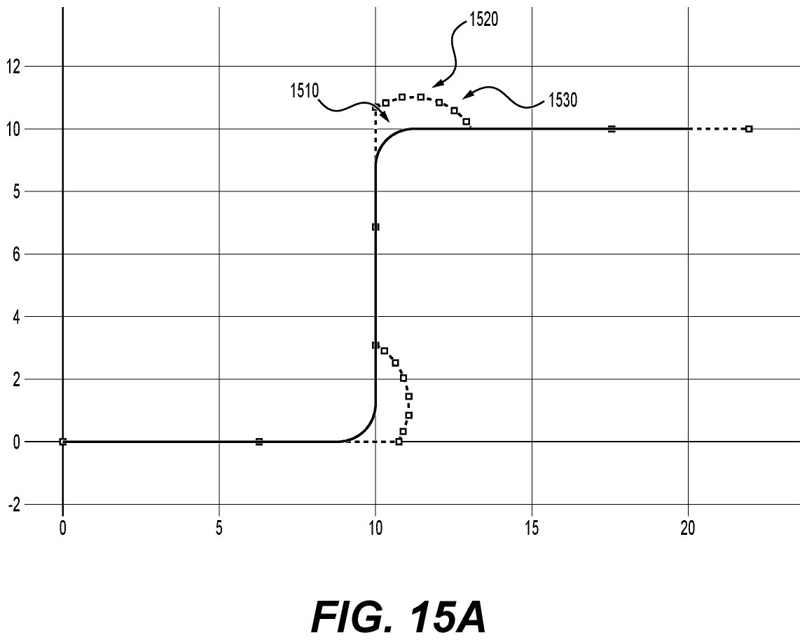

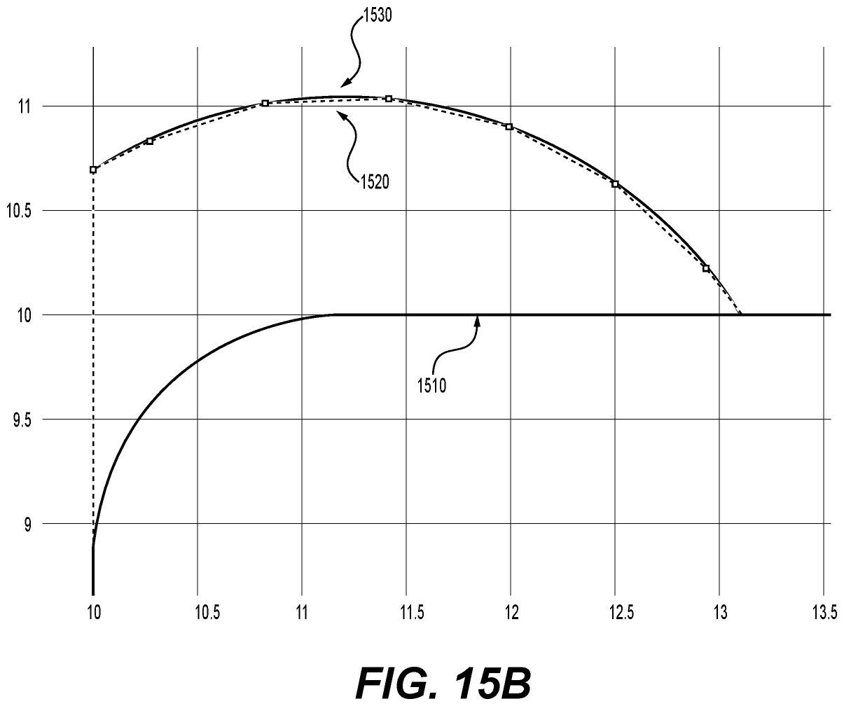

FIGS. 15A-15B illustrate a comparison of the above disclosed numerical and mathematical solutions. FIG. 15A shows a graph representing a nozzle moving along a pair of right-angled paths as followed in FIG. 7 with the simulation algorithm proceeding along a numerically compensated solution. The input path 1510 is shown filleted. The numerically compensated path 1520 and the mathematically compensated path, 1530 are shown next to one another. This view shows 1520 and 1530 are similar.

FIG. 15B shows a close-up of portion of the graph representing a nozzle moving along a pair of right-angled paths as followed in FIG. 7 with the simulation algorithm proceeding along a numerically compensated solution. The zoomed in version shows the discretization error, in this case correctly limited to 10 um.

In some embodiments, to determine whether an inversion is a good inversion simulate (compensate (path))==path.

In this example, an input path may be first compensated and then simulated. A maximum error between path and simulate (compensate (path)) of 6 um comparing that to the desired path.

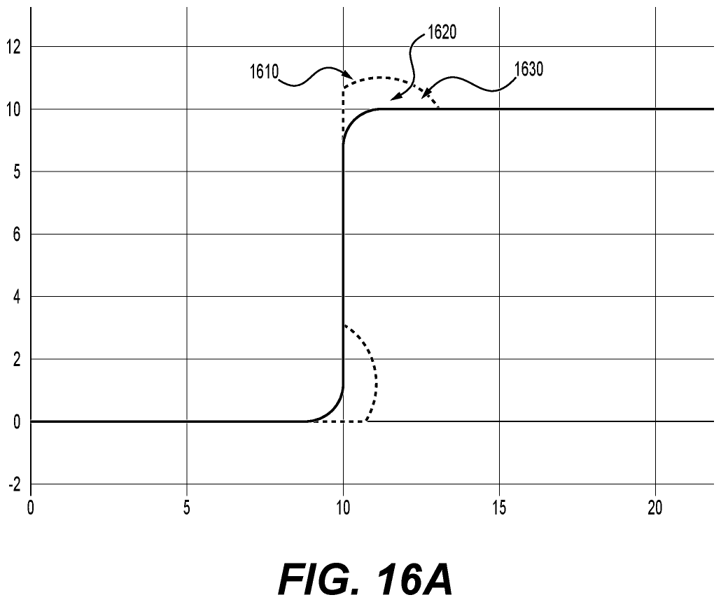

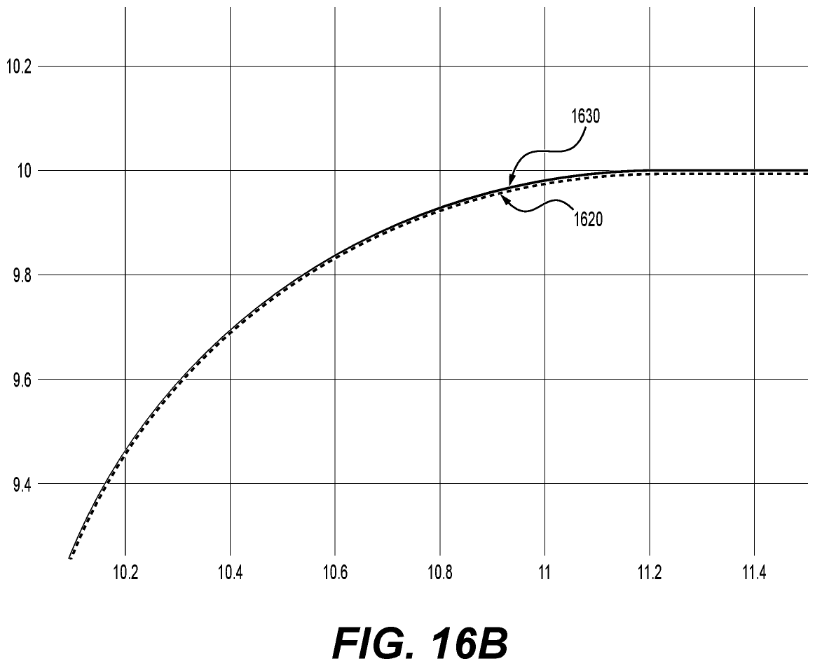

FIGS. 16A-16B illustrate nozzle movement along a pair of right-angled paths as followed in FIG. 7 and shows the maximum error between the input path and the compensated path.

FIG. 16A shows a zoomed-out graph view of path and simulate (compensate (path)) in which the curves appear on top of each other. The input path, 1610 is shown filleted. The path 1610 may be compensated to produce a compensated path 1620 and then compensated path 1620 may be simulated to produce a simulated compensated path 1630.

FIG. 16B shows a zoomed-in graph view of path and simulate(compensate (path)) in which the curves appear on top of each other. A maximum error parameter L and numerical simulation step size were both set to 5 um. A maximum error between path and simulate(compensate(path)) were found to be about 6 um, as such this error value is within the error, minus discretization effects which can easily be controlled.

A maximum error parameter L and simulation step size were each set to about 5 um, so an error of about 6 um may be reasonable.

### EXPERIMENTAL

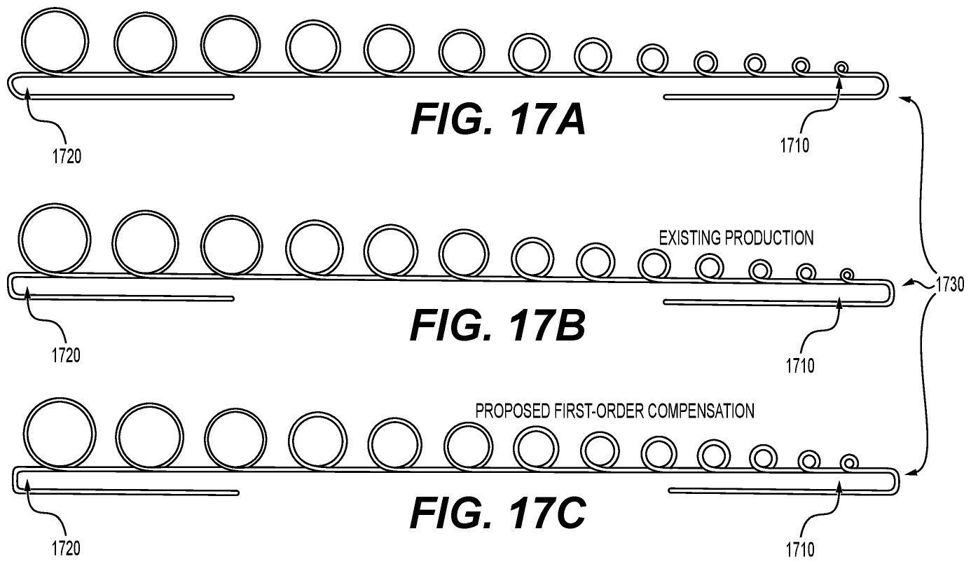

FIGS. 17A-C illustrate Experimental Results applying an inversion in practice by comparing the uncompensated results to the compensated results. FIG. 17A shows a print applying an inversion with no compensation. FIG. 17B shows a print applying a convolutional compensation. FIG. 17C shows a print applying a first order compensation according to the present invention. As can be clearly seen the smallest circles 1710 are closer to the desired radii in FIG. 17C. Moreover, the right angles at beginning/end, 1720 and 1730, respectively are much sharper and closer to the desired path.

### Extrusion Control

In practice, in addition to X-Y positional control, using extrusion control may be desirable during travel along the compensated path. Extrusion control may be obtained by way of a fiber extruder to maintain tension in the line. Using a fiber extruder in this manner may result in a slow-down in a rate of extrusion as we go around corners to account for the fact that comparatively little fiber is predicted to be laid down as the nozzle swings around compensated arcs. That is, as pathing compensation is ongoing, it should be further useful to track an amount of how much fiber may come out of the nozzle one each XY move. This is feasible including by measuring a distance along the input path and tagging waypoints on a compensated path.

These and other aspects of the invention will become apparent from the following disclosure.

Incorporation by reference is hereby made to U.S. Pat. Nos. 10,076,876, 9,149,988, 9,579,851, 9,694,544, 9,370,896, 9,539,762, 9,186,846, 10,000,011, 10,464,131, 9,186,848, 9,688,028, 9,815,268, 10,814,558 U.S. Patent Application Publication No. 2016/0107379, U.S. Patent Application Publication No. 2018/0154439, U.S. Patent Application Publication No. 2018/0154580, U.S. Patent Application Publication No. 2018/0154437, U.S. Patent Application Publication No. 2019/0009472, U.S. Patent Application Publication No. 2020/0371509, U.S. Patent Application Publication No. 2020/0361155, and U.S. patent application Ser. No. 15/459,965, filed on Mar. 15, 2017 and entitled “SCANNING PRINT BED AND PART HEIGHT IN 3D PRINTING,” in their entireties.

Although this invention has been described with respect to certain specific exemplary embodiments, many additional modifications and variations will be apparent to those skilled in the art in light of this disclosure. For instance, while reference has been made to an X-Y Cartesian coordinate system, it will be appreciated that the aspects of the invention may be applicable to other coordinate system types (e.g., radial). It is, therefore, to be understood that this invention may be practiced otherwise than as specifically described. Thus, the exemplary embodiments of the invention should be considered in all respects to be illustrative and not restrictive, and the scope of the invention to be determined by any claims supportable by this application and the equivalents thereof, rather than by the foregoing description.

Although this invention has been described with respect to certain specific exemplary embodiments, many additional modifications and variations will be apparent to those skilled in the art in light of this disclosure. For instance, while reference has been made to an X-Y Cartesian coordinate system, it will be appreciated that the aspects of the invention may be applicable to other coordinate system types (e.g., radial). It is, therefore, to be understood that this invention may be practiced otherwise than as specifically described. Thus, the exemplary embodiments of the invention should be considered in all respects to be illustrative and not restrictive, and the scope of the invention to be determined by any claims supportable by this application and the equivalents thereof, rather than by the foregoing description.

What is claimed is:

1. An apparatus comprising:
at least one processor; and
at least one memory,
wherein the at least one memory stores computer-readable instructions which, when executed by the at least one processor, cause the processor to:
receive design data corresponding to an object;
determine, based on the design data, a path of travel of a nozzle for printing at least a portion of the object;
discretize the path of travel into path segments;
for each path segment, compensate the path segment to generate a compensated path segment; and
generate a compensated path of travel based on the compensated path segments.

2. The apparatus of claim 1, wherein the compensating of a path segment includes shifting the position of the path segment.

3. The apparatus of claim 2, wherein the shifting of the position of path segment includes shifting its position along a tangent direction of the path segment.

4. The apparatus of claim 1, wherein the path segments include line segments.

5. The apparatus of claim 1, wherein the path segments include arc segments.

6. The apparatus of claim 5, wherein the compensating of an arc path segment includes shifting a position of a start point and a position of an end point of the arc path segment.

7. The apparatus of claim 1, wherein the compensating the path segment includes applying an inversion of a system model to the path segment to generate the compensated path segment.

8. The apparatus of claim 1, wherein the system model corresponds to an expected location of 3D print material deposition relative to a location of a nozzle that deposits the 3D print material.

9. The apparatus of claim 8, wherein the system model is a first order model.

10. A method comprising:
receiving design data corresponding to an object;
determining, based on the design data, a path of travel of a nozzle for printing at least a portion of the object;
discretizing the path of travel into path segments;
for each path segment, compensating the path segment to generate a compensated path segment; and
generating a compensated path of travel based on the compensated path segments.

11. The method of claim 10, wherein the compensating of a path segment includes shifting the position of the path segment.

12. The method of claim 10, wherein the shifting of the position of path segment includes shifting its position along a tangent direction of the path segment.

13. The method of claim 10, wherein the path segments include line segments.

14. The method of claim 10, wherein the path segments include arc segments.

15. The method of claim 14, wherein the compensating of an arc path segment includes shifting a position of a start point and a position of an end point of the arc path segment.

16. The method of claim 10, wherein the compensating the path segment includes applying an inversion of a system model to the path segment to generate the compensated path segment.

17. The method of claim 10, wherein the system model corresponds to an expected location of 3D print material deposition relative to a location of a nozzle that deposits the 3D print material.

18. The method of claim 17, wherein the system model is a first order model.

19. A non-transitory computer-readable medium storing a computer program which, when executed by at least one processor, causes the processor to:
receive design data corresponding to an object;
determine, based on the design data, a path of travel of a nozzle for printing at least a portion of the object;
discretize the path of travel into path segments;
for each path segment, compensate the path segment to generate a compensated path segment; and
generate a compensated path of travel based on the compensated path segments.

20. The non-transitory computer-readable medium of claim 19, wherein the compensating the path segment includes applying an inversion of a system model to the path segment to generate the compensated path segment.
